(19) United States
(12) Patent Application Publication
(10) Pub. No.: US 2003/0026554 A1
(43) Pub. Date: Feb. 6, 2003

(54) Multi-channel fiber-optical connector

(75) Inventors: Yong-Sung Jin, Sunnyvale, CA (US); Hoon-Jin Yoon, Incheon (KR); Hyung-Jae Lee, Sunnyvale, CA (US); Hee-Suk Song, Kyunggi (KR); Yung-Sung Son, Sunnyvale, CA (US)

Correspondence Address: SKJERVEN MORRILL LLP, 25 METRO DRIVE, SUITE 700, SAN JOSE, CA, 95110, US

(73) Assignee: PhotonAge, Inc.

(21) Appl. No.: 09/907,521

(22) Filed: Jul. 16, 2001

(51) Int. Cl. G02B 6/43

(52) U.S. Cl. 385/89; 385/52

(57) ABSTRACT

An optical connector capable of precisely aligning optical fibers with optical devices in a passive fashion is presented. The connector includes a fiber block and a device module. The fiber block can receive optical fibers and where the cores of the optical fibers are positioned in V-grooves. The device module receives optical devices in inserts formed in the device module such that electrical connections can be accomplished between electrical leads formed in the device module and the optical devices. The fiber block and the device module include complementary alignment mechanisms so that a precise alignment of the optical fibers with the optical devices can be accomplished. In some embodiments, the complementary alignment mechanism can be alignment holes and corresponding pins formed in the fiber block and device module. In some embodiments, a cover latched on the device module includes springs which hold the fiber block firmly in place in the device module.

### BACKGROUND

1. Field of the Invention

The present invention relates to a multi-channel optical connector and, more particularly, to a multi-channel optical connector for use with optical transmitter modules and optical receiver modules.

2. Description of the Related Art

Recently, communication systems designers are vigorously adapting their designs for the use of optical fiber technology in various communication fields. Optical communication systems enable use of high frequency signals and suffer less signal loss than conductor based technologies and are therefore better suited for the high bandwidth communications that are increasingly in demand. Optical communication systems are suitable to use in high speed-long distance transmission systems.

During optical transmission of data, one channel of serial data is generally utilized for transmitting parallel data on N channels. In this case, the transmission speed of the serial data should be at least N times faster than each of the parallel data channels. High speed transmission circuits require expensive equipment; therefore, multiple transmission channels are often utilized to reduce the burden of a high speed transmitting circuit. In order to use multiple optical channels, a plurality of optical transmission systems, each including a light source, an optical fiber, and light detector, are required. For multi-channel optical transmitter/receiver modules, an accurate alignment of optical fibers with sources and detector is required not only for each channel but also for adjacent channels. Therefore, multi-channel optical transmitter/receiver modules need an optical connector which is highly accurate and, consequently, is more complicated than that of a single channel optical transmitter/ receiver module.

FIG. 1 is an exemplary schematic diagram illustrating an active alignment method for a multi channel optical connector 101 and laser diodes 100. In order to arrange laser diodes 100, for example, with respect to optical fibers 110, laser diodes 100 are first fixed so that they are separated by regular, usually uniform, intervals. Next, optical fibers 110 are fixed on a block 120 having grooves with the same regular intervals with which the laser diodes have been fixed. Then, laser diodes 100 and optical fibers 110 are aligned by moving block 120 with respect to laser diodes 100. Block 120 can be moveable in all three directions. An optimal alignment between optical fibers 110 and laser diodes 100 can be achieved by monitoring the optical output power from each optical fiber of optical fibers 110 while moving block 120. When the output power from each of the optical fibers 110 is maximized, block 120 can be fixed relative to diodes 100. This method is referred to as the active alignment method because the maximum output power is sought by monitoring the optical output power from fibers 110. The active alignment method can approach the optimum arrangement, however it requires expensive equipment and a lot of labor hours to accomplish. Further, the active alignment method does not lend itself to systems where plugable connectors are desirable.

FIG. 2 is an exemplary schematic diagram illustrating a passive alignment method for a multi channel optical connector 201 and optical devices 200. In contrast to the active alignment method illustrated in FIG. 1, the passive alignment method does not include monitoring optical output power. Multi channel optical connector 201 includes an optical device array block 210 with optical devices 200, each electrically coupled to one of electrical conductors 211, arranged to have regular, uniform, intervals. Multi channel optical connector 201 also includes a multi channel optical fiber block 220 having optical fibers 221 arranged with the same regular intervals as that of optical devices 200 of optical device array block 210. Optical device array block 210 can be fixed on a substrate (not shown) by soldering. Multi channel optical fiber block 220 can be plugable. Optical fibers 221 are then aligned with optical devices 200 when multi channel optical fiber block 220 is plugged into optical device array block 210. Optical devices 200 can be laser diodes or photodiodes. Even though the passive alignment method is not optimized as with the active alignment method, it has the advantage of being faster (requiring fewer labor hours), requires less expensive equipment, and therefore is less expensive to perform.

FIG. 3 illustrates a conventional method of assembling connector 201 of FIG. 2. Typically, an optical transmitter/receiver module will include two connectors such as connector 201 of FIG. 2, arranged such that light sources in one module are coupled with light detectors in the other module via optical fibers. Optical fibers 320 are inserted in grooves 311 on a connector block 310. Optical fibers 320 can be multi mode or single mode optical fibers. Grooves 311 guide optical fibers 320 into holes 322, typical 250 μm diameter holes, in connector block 310. Grooves 311 have uniform intervals between any two adjacent grooves 311. Optical fibers 320 are fixed in place by a cover 300, which can also be grooved with grooves 312 having the same uniform intervals as connector block 310. Connector block 310 is usually made from a plastic material for ease of manufacturing and lowered cost. End facets 321 of optical fibers 320 are usually smoothly polished in order to facilitate the coupling of light into and out of optical fibers 320.

TABLE 1 shows the result of a calculation for an allowable tolerance of the alignment depending on the various diameters of optical fibers and a coupling efficiency between the optical fiber and the optical devices. The calculations in TABLE 1 are based on several parameters. The allowable tolerance for alignment between a laser diode and an optical fiber is based on the requirement that more than about 90% of the maximum optical output of the laser diode be coupled into the optical fiber. The allowable tolerance of alignment between an optical fiber and a photo diode is based on the requirement that more than about 90% of the maximum light output from the optical fiber be coupled into the photo diode. The divergence angle of the laser diode beam is assumed to be about 15° . The diameter of the light receiving aperture of the photodiode is assumed to be about 200 μm. Additionally, the laser diode is separated by about 450 μm from the optical fiber.

TABLE 1

| | Laser diode | Optical fiber | Laser diode | Optical fiber | |
|---|---|---|---|---|---|
| | — | — | — | — | |
| Optical | Optical fiber | Photo diode | Optical fiber | Photo diode | Total |
| fiber | Allowable | Allowable | Maximum | Maximum | maximum |
| core | tolerance of | tolerance of | coupling | coupling | Coupling |
| diameter | alignment | alignment | efficiency | efficiency | efficiency |
| 0.5 mm | ± 140 μm | ± 90 μm | 100% | 21% | 21% |
| 0.25 mm | ± 40 μm | ± 45 μm | 90% | 67% | 60% |
| 0.0625 mm | ± 20 μm | ± 65 μm | 16% | 100% | 16% |

If a 0.5 mm core diameter plastic optical fiber is used, it would be possible to manufacture a connector having approximately 100 μm of allowable tolerance of alignment between the optical fiber and the laser diode by plastic molding. However, only 21% of the light output from the optical fiber can be coupled into the photodiode. Alternatively, if a 0.25 mm core diameter plastic optical fiber is used, 67% of the light output from the optical fiber can be coupled to the photodiode. The decreased diameter of the optical fiber can bring three times the signal to the photo diode without increasing the output of the laser diode; however, the allowable tolerance of alignment between the optical fiber and the laser diode would be reduced by an amount 0.29 that of the 0.5 mm diameter plastic optical fiber. It is very difficult to manufacture such a connector and satisfy the allowable tolerances with plastic molding. The passive alignment method is generally accomplished with plastic optical fiber having relatively large diameters, generally about 0.5˜1.0 mm, for proper transmission of the optical signal.

If a 0.0625 mm diameter multi mode silica optical fiber is used, it is extremely difficult to satisfactorily manufacture the connector with the required reduced alignment tolerances by plastic molding. However, even though the amount of the output of the laser diode actually coupled into the multi mode silica optical fiber is small, all of the light coming out from the optical fiber can be coupled into the photodiode. Thus, the maximum output of the photodiode is almost the same as that of the 0.5 mm diameter optical fiber. The silica optical fiber is essential, however, for high speed-long distance signal transmission because silica optical fiber has almost no loss of power and a high cut-off frequency compared with plastic optical fiber. One drawback of using multi mode silica fiber is the small allowable tolerance in the alignment of fiber core with the laser diode. If the tolerance is exceeded the coupling efficiency will decrease, thereby increasing the loss in signal power.

FIG. 3A shows a typical optical fiber prepared for insertion into grooves 311 of connector block 310 (FIG. 3). Optical fiber 320 is a buffered optical fiber having a buffer 340. Buffer 340, for example, can be a 900 μm diameter buffer. Buffer 340 is stripped away to expose buffer 341. Buffer 341, for example, can be a 250 μm diameter buffer. Buffer 341 is inserted into one of holes 322 in connector block 310 and is guided by grooves 311. The center of buffer 341, however, may not be aligned with the center of fiber core 343, even though holes 321 have uniform intervals. Therefore, the centers of fiber core 343 may be arranged with non-uniform intervals.

However, the center of fiber core 343 is well aligned with the center of bare fiber 342, which may be a 125 μm diameter fiber. If bare fiber 342 were placed into grooves 311 instead of buffer 341, the center of core 343 can be aligned accurately. However, it is difficult to make small diameter holes and grooves (125 μm diameters, for example) using plastic injection molding since a very small and long needle-shaped molding core, which can be easily broken, is needed. Additionally, since the small diameter buffer 341 is fixed in connector block 310 while the large diameter buffer 340 is not, stress is induced at the junction between buffer 340 and buffer 341. FIG. 3B shows a conventional assembly of a plurality of buffered fibers 330, which can be 900 μm buffered fibers, and a conventional connector 332.

Therefore, there is need for a multi-channel optical connector capable of being precisely aligned in a fast, cost sensitive fashion to yield low loss connections especially for multimode fiber with 62.5 or 50 μm diameter.

### SUMMARY

In accordance with the present invention, a multi-channel optical connector is disclosed that enables accurate alignment of optical fibers and optical devices, and can support transmission of high frequency signals without interference or noise.

An optical connector according to the present invention includes a fiber block and an optical device module. In some embodiments, a connector according to the present invention can include a connector cover. The fiber block receives optical fibers such that the fiber cores of the optical fibers are held in a V-grooved fiber holder formed in the fiber block. In some embodiments, a glass block formed to be received into the fiber block is epoxied over the V-grooves once the optical fiber cores are in place in order to hold the optical fibers in place. The optical device module can hold optical devices in inserts formed in the device module. Electrical connections can be made between the optical devices and electrical leads formed in the device module once the optical devices are placed into the device module.

The fiber block and the optical device module slidably attach. Alignment between the fiber connector and the optical device module is accomplished, at least partially, with alignment holes and complementary alignment pins formed in the fiber block and the device module. In some embodiments, other complementary pairs of alignment mechanisms can be formed, for example tracks to receive a slidable rail. With the fiber block inserted into the device module, fiber cores mounted in the V-grooves of the fiber block can be precisely aligned with optical devices mounted into inserts of the device module.

In some embodiments, the fiber block includes fiber holes and the device mounting module includes alignment pins so that when the fiber connector is positioned within the device mounting module the holes and pins align and align the optical fibers with respect to the optical devices. The cover, then, can slide over the attached fiber connector and device module in order to hold the optical connector together. In some embodiments, the cover includes a spring and a latch. The latch attaches to a latch guide and holder formed in the device module. When latched, the springs contact the fiber block and hold the fiber block firmly in place in the device module, further holding the alignment of optical fibers with optical devices.

In some embodiments, the holes can be formed in the device mounting module while the pins are formed on the fiber connector. In some embodiments each of the fiber connector and the device mounting module can include holes and pins.

These and other embodiments of the invention are further discussed below with reference to the following figures.

### BRIEF DESCRIPTION OF THE FIGURES

FIG. 1 shows an exemplary schematic diagram illustrating an active alignment method for a multi channel optical connector.

FIG. 2 shows an exemplary schematic diagram illustrating a passive alignment method for a multi channel optical transmitter.

FIG. 3 shows an assembly diagram of a conventional method of implementing the passive alignment method for the multi-channel optical fiber block.

FIG. 3A shows a buffered optical fiber.

FIG. 3B shows a conventional connector assembly having buffered fibers.

FIG. 4 shows a schematic block diagram of an optical transmitter/receiver system having an optical transmitter/receiver module according to the present inventions.

FIG. 5 shows the variation of the output power from an optical fiber depending on the misalignment between the beam from a laser diode and the center of the cross-section of an optical fiber.

FIGS. 6A, 6B and 6C show an optical connector in accordance with the present invention and assembly of the optical connector.

FIGS. 7A, 7B, 7C, and 7D illustrates assembly of a fiber block according to the present invention and insertion of optical fibers into the fiber block.

FIGS. 8A, 8B, 8C, and 8D illustrate assembly of a device module according to the present invention and insertion of optical devices in the device module.

FIGS. 9A and 9B show a cross-sectional view of a connector according to the present invention.

FIGS. 10A and 10B illustrate a particular embodiment of a fiber block according to the present invention.

FIGS. 11A, 11B and 11C illustrate a particular embodiment of a device module which operates with the fiber block illustrated in FIGS. 10A and 10B.

In the figures, elements having the same designation in the various figures have the same or similar function.

### DETAILED DESCRIPTION

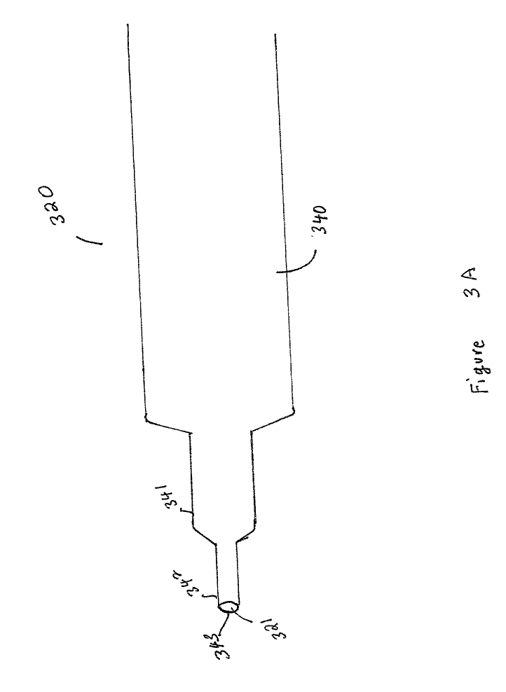

FIG. 4 illustrates a schematic block diagram of an optical transmitter and receiver system 90 having a multichannel optical transmitter/receiver module 80. Module 80 includes a device module 61a having a light source 60a, a device module 61b having a detector 60b, a fiber optic cable having an optical fiber 70 and connectors 50a and 50b, one at each end of the fiber optic cable. Each module 61a and 61b can be a transmitter/receiver module and can both transmit and receive optical signals. In FIG. 4, data is transmitted from a parallel data bus 10a at point A to a parallel data bus 10b at point B through multichannel optical transmitter/receiver module 80. Parallel data from parallel data bus 10a at point A is transformed to serial data for transmission by parallel/serial converting circuit 20a. The serial data is then input to a laser driving circuit 30, which transforms electrical signals representing the serial data to optical signals by appropriately driving a light source 60a in optical device module 61a. The optical signal is transmitted to a detector 60b in optical device module 61b at a receiving site near point B through connectors 50a and 50b and optical fiber 70. Detector 60b generates electrical signals based on the transmitted optical signals. Because the electrical signals coming from photodiode 60b may be weak, the electrical signals can be amplified and restored to digital format to recover the originally transmitted electrical signals by an amplifier/signal recovery circuit 40. The recovered electrical signals are then converted back to parallel data format by a serial/parallel converting circuit 20b and coupled to parallel data bus 10b at point B. The transmission of data from point A to point B is, then, accomplished by transmitting serial data through optical fiber 70. In general, optical transmitter and receiver system 90 can transmit either parallel formatted data or serially formatted data from point A to point B. Optical device module 61a can have more than one light source 60a and may include detectors; optical device module 61b can have more than one photodiode 60b ; and connector 50a and 50b can receive more than one fiber 70.

Optical transmitter/receiver module 80 converts the electrical signals representing serial data to an optical signal, transmits the optical signal over a distance, and converts the optical signal to electrical signals representing the serial data. As shown in FIG. 4, optical transmitter/receiver module 80 includes a light source 60a for converting the electrical signal to light, an optical fiber 70 for transmitting the light and a light detector 60b for reconverting the transmitted light to electrical signals. An optical connector 50a couples light from light source 60a into optical fiber 70 and another optical connector 50b couples light from optical fiber 70 into light detector 60b . Light source 60a must be accurately arranged with respect to optical fiber 70 in order to optimize the coupling of light into optical fiber 70. Optical fiber 70 must also be accurately arranged with respect to light detector 60b in order to optimize the coupling of light from optical fiber 70 into detector 60b . The transfer of optical signals between source 60a and detector 60b , then, should be optimized to reduce the signal power loss and enable restoration of the serial data electrical signal originally transmitted. Therefore, it is very important to accurately align the output beam of light source 60a to optical fiber 70 and the output beam from optical fiber 70 to light detector 60b at optical connectors 50a and 50b, respectively.

Generally, light source 60a can be a laser diode (e.g. an edge emitting laser diode or a surface emitting laser diode) or LED and detector 60b can be a photodiode, although any other source of light or detection system can be used. An edge emitting laser diode should be diced for testing of the chip characteristics. A surface emitting laser diode, however, enables testing of chip characteristics on the wafer unit without dicing and is suitable for mass production. Additionally, surface emitting laser diodes have the advantage of requiring a lower driving current driver (e.g., laser driver 30) than edge emitting laser diodes. Also, because the light beam from an edge emitting laser diode is badly distorted with an elliptical shape, it is more difficult to couple the beam into the circularly shaped cross section of the optical fiber. An emitted light beam from a surface emitting laser diode can be the same circular shape as the cross section of the optical fiber and most of the light beam emitted can be coupled into the optical fiber. Therefore, surface emitting laser diodes are better suited for a passive alignment method because the passive alignment method is less accurate than the active alignment method.

Optical fiber 70 can be classified as single mode or multi-mode depending on a core size of optical fiber 70, which is typically made from silica or plastic. A single mode optical fiber is more suitable than multi-mode optical fibers for high-speed, long-distance transmission of data. Optical fibers made from silica have better transmission properties, leading to less power loss, than optical fibers made from plastic. Because the core diameter of a single mode silica optical fiber is less than about 10 μm, it is very difficult to align source 60a to optical fiber 70 in order to couple light from light source 60a to optical fiber 70. Therefore, connector 50a needs to be a high accuracy optical connector. Alternatively, a multi-mode optical fiber having a core diameter of more than 50 or 62.5 μm requires relatively little accuracy in alignment in order to couple light from source 60a to optical fiber 70. A plastic optical fiber typically has a core diameter of about 250˜1000 μm and therefore it is relatively easy to couple light into and out of the plastic optical fiber.

FIG. 5 shows that the plastic optical fiber, with a core diameter of 0.5 mm, has an output power nearly 100% of the maximum output power even if the light beam from the light source is miss-aligned by about 100 μm from the center of the optical fiber. In contrast, if multi-mode optical silica fiber with a core diameter of 0.0625 mm is misaligned by approximately 20 μm, the output power of the optical fiber is sharply reduced.

As an additional difficulty, a typical photodiode utilized in high-speed transmission systems has a light receiving area with diameter of about 100˜200 μm. Because the photodiode has such a small diameter, optical fiber 70 needs to be precisely aligned with photodiode 60b in optical connector 50b.

Copending U.S. patent applications entitled “Multichannel Optical Transmitter/Receiver Module and Manufacturing Method Thereof,” Ser. No. 09/608207 and “Rugged Type Multi-Channel Optical Connector,” Ser. No. 09/608,478, each of which is assigned to the same entity as is the present invention, each of which is included herein by reference in their entirety, describe connectors that address the alignment problem. Embodiments of the present invention provide further precision in alignment.

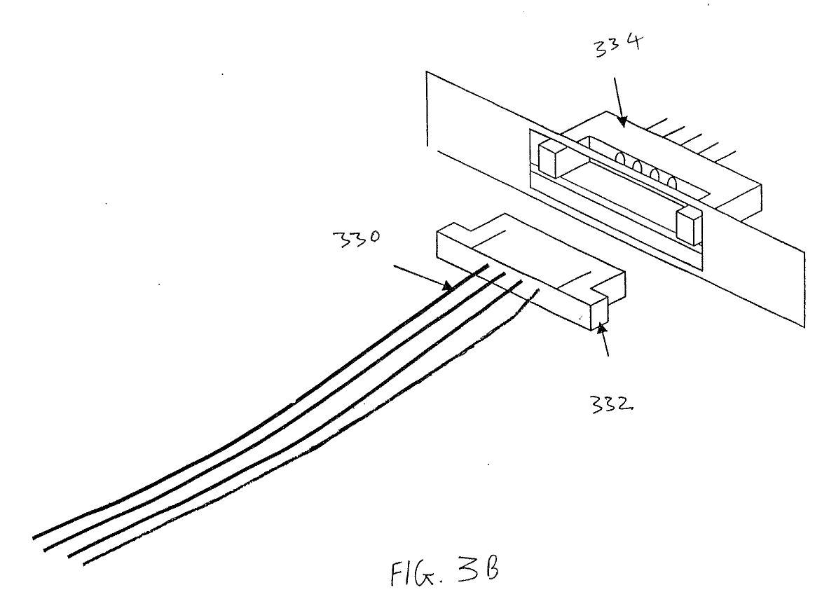

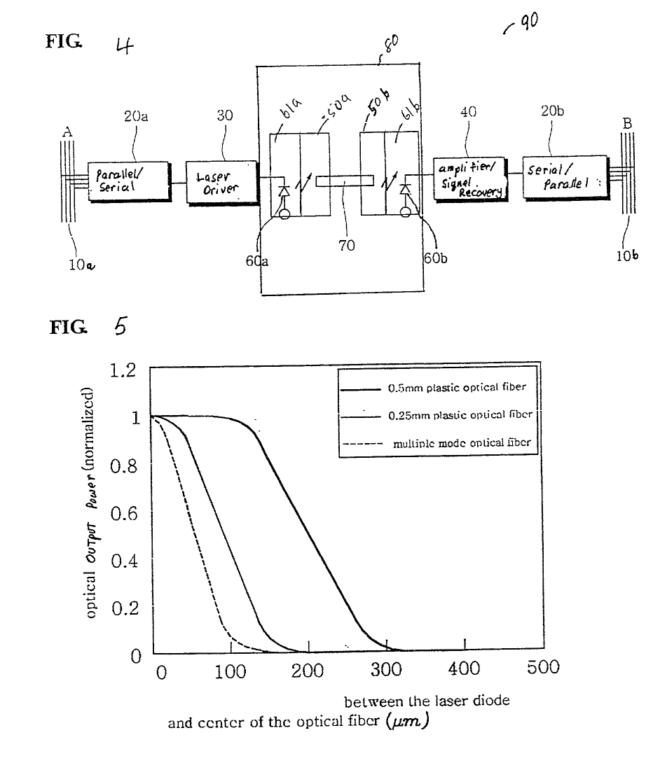

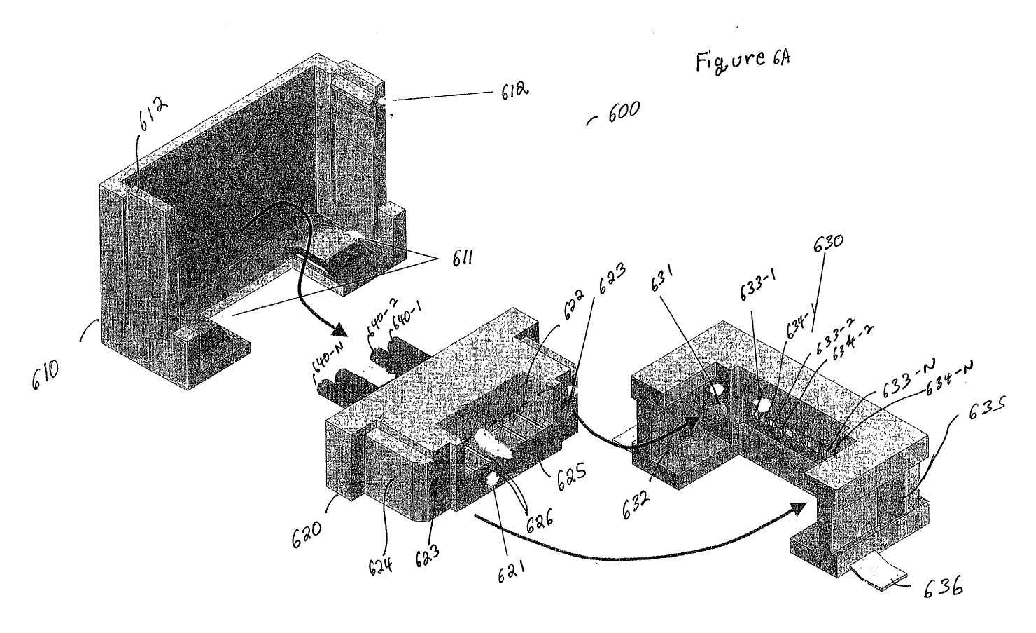

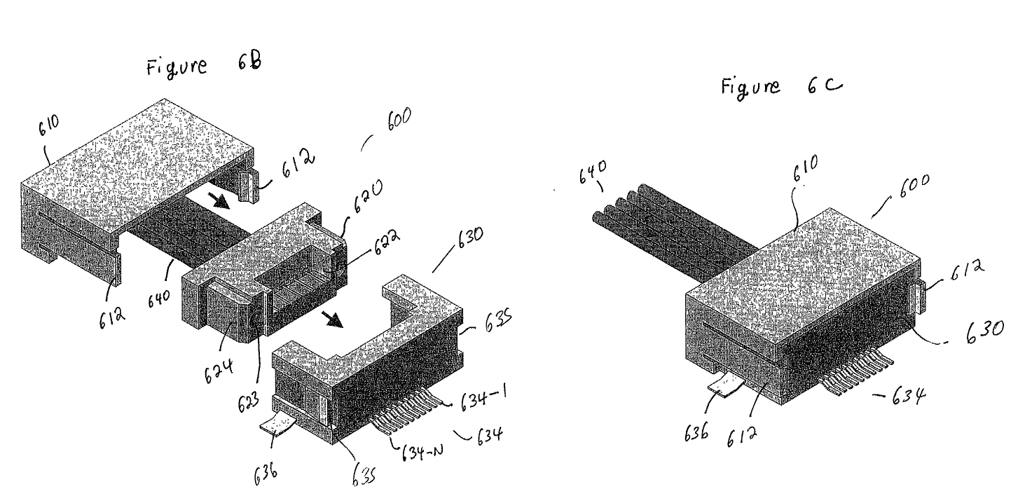

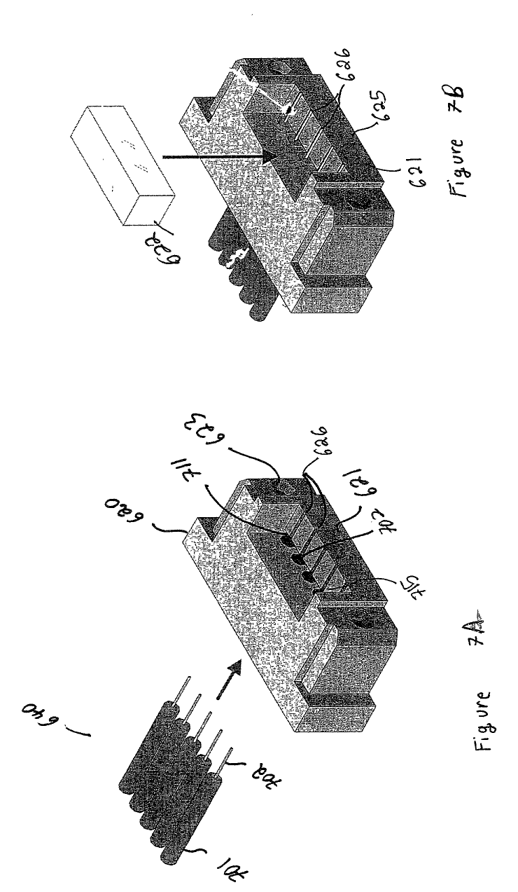

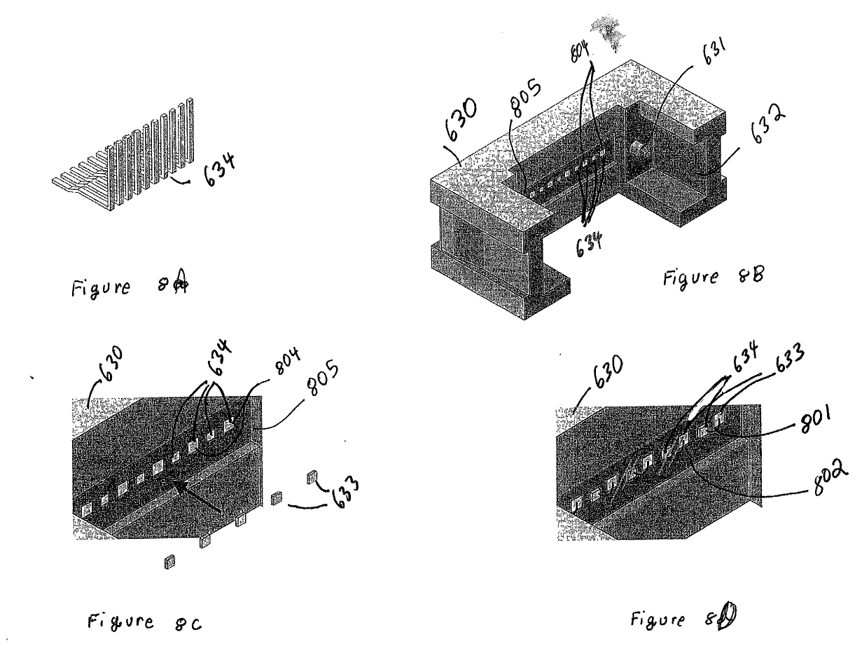

FIG. 6A shows an embodiment of a multi-channel fiber connector 600 according to the present invention. Connector 600 can be connector 50a or 50b of transmitter/receiver module 80. Connector 600 includes a fiber block 620, and an optical device module 630. Further, in some embodiments, connector 600 can include a cover 610. Cover 610, fiber block 620, and device module 630 can each be formed by plastic molding (e.g., injection molding) and therefore can be easily manufactured. Embodiments of fiber block 620 receive any number of optical fibers 640 (fibers 640-1 through 640-N are shown in FIG. 6A). Optical fibers 640 can be of any type of optical fiber, including those discussed above. Further, embodiments of device module 630 can receive any number of optical devices 633 (devices 633-1 through 633-N are shown in FIG. 6A). Optical devices 633 can be any optical devices, including laser sources and optical detectors as discussed above.

Cover 610 includes formed plastic springs 611 and latchs 612. In the embodiment shown in FIG. 6A, latchs 612 are formed from a spring plate and a latch. Fiber block 620 includes guides 624 and alignment holes 623. Guide 624 allows fiber block 620 to be slidably inserted into a complementary guide 623 of device module 630. Alignment holes 623 receive complementary pins 631 formed in device module 630. In some embodiments, alignment holes 623 and complementary pins 631 can be replaced by other alignment mechanisms and their complements, respectively. For example, alignment holes 623 can be replaced by precisely formed tracks and pins 631 can be replaced by rails which are inserted into the tracks.

Fiber block 620 receives fibers 640-1 through 640-N (collectively fibers 640) and positions the cores of fibers 640 in corresponding ones of V-grooves 626. V-grooves 626 can be formed in a V-block 621 of fiber block 620 with precise spacing so that fibers 640 are easily aligned within fiber connector 620. In some embodiments, a glass or plastic positioning block 622 can be mounted and epoxied over V-grooves 626 with the cores of fibers 640-1 through 640-N in place so that the cores of fibers 640-1 through 640-N are held within respective ones of V-grooves 621. Furthermore, in some embodiments, fibers 640 can be epoxied in place in fiber block 620. In some embodiments, surface 625 on V-block 621 can be polished, for example by lapping and polishing, to create an optical-quality flat surface.

Device mounting block 630 is formed to include a guide 632 to receive complementary guide 624 of fiber connector 620. Further, device mounting block 630 includes pins 631 formed to be received by complementary holes 623 of fiber connector 620. In some embodiments, device mounting block 630 can include holes and fiber connector 620 can include pins. Further, in some embodiments device mounting block 630 can include attachment wings 636 for mounting device mounting block 630 to a printed circuit board or other surface. Further, device mounting block 630 can include latch guide and holder 635 for receiving latches 612 of cover 610. Device mounting block 630 further includes electrical leads 634-1 through 634-2N positioned to be electrically coupled to optical devices. Each of optical devices 633-1 through 633-N can be coupled to two of electrical leads 634-1 through 634-2N. Optical devices 633-1 through 633-N, then, can be positioned with a back in electrical contact with alternate ones of electrical leads 634-1 through 634-2N and attached to device mounting block 630. Devices 633-1 through 633-N (collectively devices 633) can then be electrically coupled to the opposite alternate ones of electrical leads 634-1 through 634-2N (collectively electrical leads 634), respectively. Optical devices 633-1 through 633-N can be any optical source or optical detector.

FIG. 6B illustrates the operation of completing connection, i.e. assembling, of connector 600. In FIG. 6B, optical fibers 640 and cover block 622 have been positioned and fixed (e.g., by epoxying) on fiber connector 620. Further, optical devices 633 have been mounted in optical device module 630 and electrically coupled to electrical leads 634. As shown in FIG. 6B, then, fiber block 620 is positioned relative to device mounting block 630. Fiber block 620 can then be positioned in device module 630 by inserting guides 624 of fiber connector 620 into receiving guides 632 of device mounting block 630, and sliding fiber block 620 into device mounting block 630 so that pins 631 are received into alignment holes 631.

With pins 631 inserted into alignment holes 623, optical fibers 624 can be precisely aligned with optical devices 633. In some embodiments, pins 631 and alignment holes 623 can be precisely formed in order to allow for precise alignment of optical fibers 624 with respect to optical devices 633 when pins 631 are firmly slid into holes 623. Guides 624 and complementary guides 632 allow fiber block 620 to be guided into device module 630 so that pins 631 and alignment holes 623 align.

Once fiber connector 620 is slid into device mounting block 630 so that pins 631 are positioned into holes 623, cover 610 can be slid over fiber connector 620 and device mounting block 630 so that latch 612 is firmly coupled with latch guide and holder 635. Springs 611 then contact with fiber connector 620 and firmly hold fiber connector 620 in place in device module 630, further holding fibers 640 aligned with optical devices 633.

FIG. 6C shows a fully assembled connector 600. Cover 610 is slid over device mounting block 630 so that latches 612 are firmly attached in latch guide and holders 635. Optical fibers 640, then, are precisely aligned with optical devices 633, which are electrically coupled to electrical leads 634. Device module 630, typically prior to assembly of connector 600 as shown in FIG. 6B, can be structurally attached to a flat surface, for example a printed circuit board, with attachment wings 636 and electrically coupled through electrically leads 634 to external circuitry. Therefore, once assembled connector 600 is structurally coupled to a surface and electrically coupled to outside circuitry. Therefore, signals on optical fibers 640 can be precisely coupled electrically to outside circuitry.

FIGS. 7A and 7B illustrate insertion of optical fibers 640 into fiber block 620. Fibers 640 are prepared by stripping away buffer 701 surrounding core 702 over a length of optical fiber on each of optical fibers 640-1 through 640-N. Each of optical fibers 640 can then inserted into a corresponding one of receiving holes 711 until buffer 701 is in contact with stop 702. In some embodiments, contact stop 702 includes a step 715 to relieve stress on core 702, which may not be precisely aligned with the center of buffer 701. Core 702 of each of fibers 640 is then positioned into its respective one of V-grooves 626 in V-block 621. As shown in FIG. 7C, epoxy can be inserted into epoxy insertion holes 712 to hold fibers 640 in place at their buffers 701. Further, as shown in FIG. 7B, a cover 622, which can be a glass cover, can be epoxied in place over V-block 621, holding each of cores 702 of optical fibers 640 into its respective one of V-grooves 626. FIG. 7D shows a front view of one of trenches 710. As shown in FIG. 7D, V-grooves 626 are arranged so that core 702 of each of fiber 640 is snuggly held by cover 622 into one of V-grooves 626.

In some embodiments, V-grooves 626 and receiving hole 711 are arranged to receive a 0.125 mm diameter core 702. However, embodiments of the invention can be arranged to receive any sized optical fiber. V-grooves 626 are formed to receive core 702. In general, V-grooves 626 can be of any length, however in some embodiments V-grooves 626 can be about 2 mm in length. Once fibers 640 are inserted into fiber block 620, core 702 of optical fibers 640 can be cut to be flush with the edge of fiber block 621. In some embodiments, the surface of the edge of fiber block 620 at the ends of V-grooves 626, surface 625, can be optically polished by a lapping and polishing process.

Fiber block 620 itself can be formed by molding plastic, usually injection molding. Injection molding plastic pieces to precise measurements is well known in the art and will not be further explained here. The dimensions of Fiber block 620 is dependent upon the number of optical fibers 640 and their type. For example, for an array of five optical fibers 640-1 through 640-5 with core 702 diameters being about 0.125 mm, fiber block 620 may be produced as shown in FIGS. 10A and 10B.

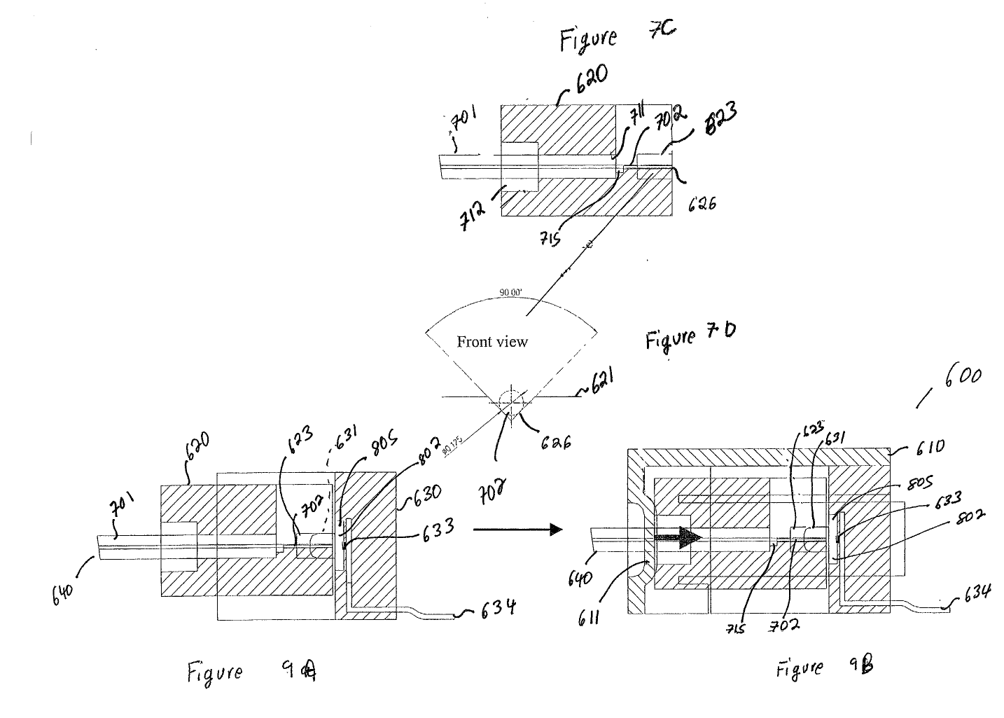

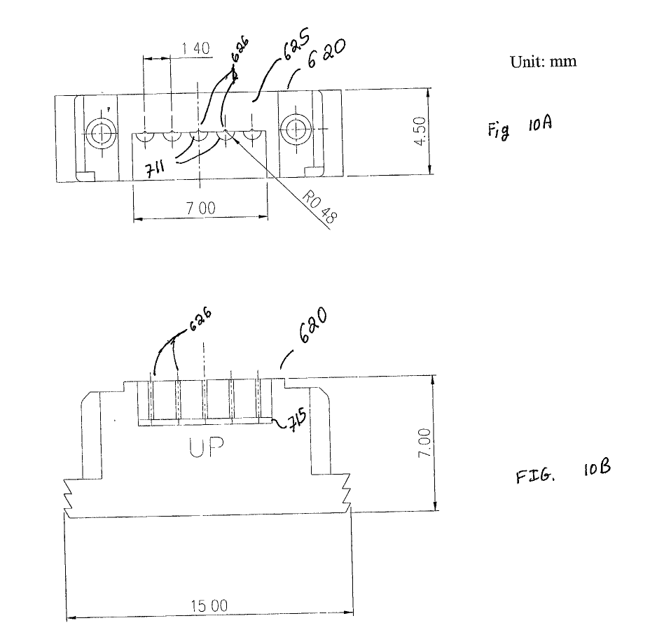

FIGS. 8A, 8B, 8C, and 8D illustrate formation of device mounting block 630 and positioning of optical devices 633 on device mounting block 630. In FIG. 8A, electrical leads 634 are shaped by bending leads 634 to form an angle. In FIG. 8B, device mounting block 630 is formed by molding plastic around electrical leads 634. Device mounting block 630 includes pins 631 for aligning with holes 623 formed in fiber block 620. Additionally, device mounting block 630 includes a device area 805 formed into the inside surface of device mounting block 630. Device area 805 includes exposed areas of electrical leads 634 and additionally, over every other one of electrical leads 634, insertions 804 for receiving and positioning optical devices. In that manner, when optical devices 633 are mounted within insertions 804, the back-side of optical devices 633 contact one of electrical leads 634.

FIG. 8C shows the positioning of optical devices 633 into insertions 804 such that optical devices 633 contact a surface of electrical leads 634 exposed by insertions 804. Additionally, electrical leads 634 are alternately exposed by insertions 804 for receiving optical devices 633 and simply exposed. FIG. 8d illustrates that exposed ones of electrical leads 634 are then electrically coupled to the front surface of mounted optical devices 633, for example by ball-bonding gold wire 801 between exposed electrical leads 634 and the front surface of optical devices 633. Therefore, voltages can be applied across and currents measured from optical devices 633 through adjacent pairs of electrical leads 634. Device area 805 can then be filled with optical epoxy 802 to fix optical devices 633 and electrical connections 801 in place.

FIG. 9A shows a cross-sectional view of fiber block 620 inserted into device module block 630. Pin 631 of device module 630 is firmly inserted into alignment hole 623 of fiber block 620. In those circumstances, core 702 of optical fiber 640, which is mounted in V-block 621 as described above, is flush with the back of fiber block 620 and is positioned close to device area 805, which is filled with optical epoxy 802. Core 702, then, is aligned with optical device 633 which is mounted such that its back side is in electrical contact with one of electrical leads 634.

FIG. 9B shows a cross-sectional view of connector 600 with cover 610 inserted over fiber block 620 and device mounting block 620 as shown in FIG. 9A. Latch 612 of cover 610 is firmly attached to latch guide and holder 635 of device mounting block 630. Under those circumstances, spring 611 is in contact with fiber block 620 and applies a force to hold fiber block 620 firmly into device mounting block 630. Therefore, the alignment between core 702 of optical fiber 640 and optical device 633 is maintained.

The embodiments of connector 600 shown in FIGS. 6A through 9B are passively aligned. Precise alignment can be achieved because of the precision placement of V-grooves 626 and insertions 804. The relative alignment of V-grooves 626 and insertions 804 is precisely ensured by alignment hole 623 and pin 631.

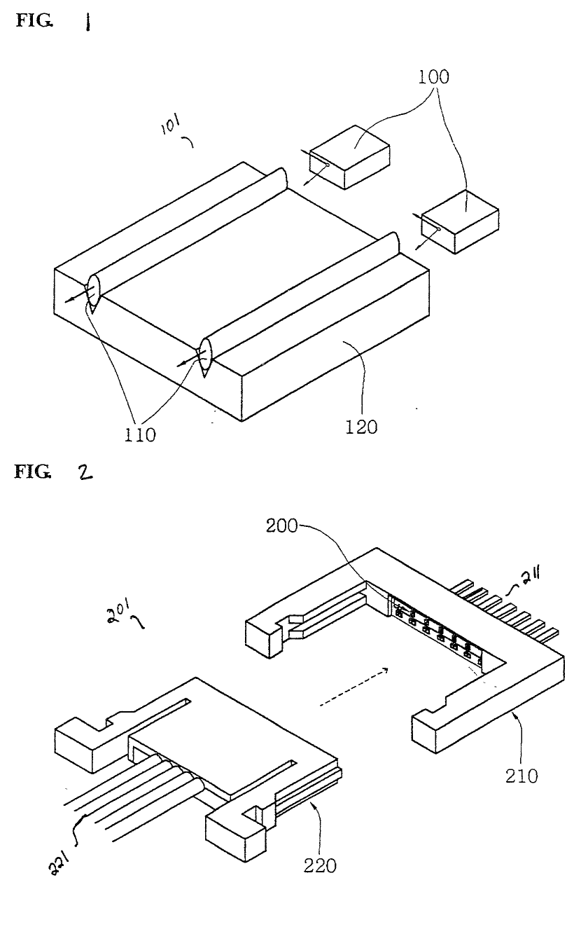

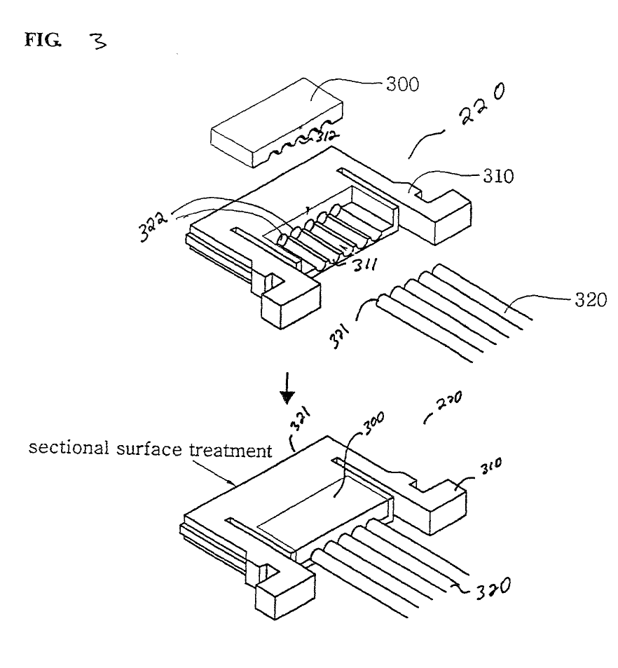

FIGS. 10A and 10B show a particular embodiment of fiber block 620 according to the present invention. FIG. 1OA shows an edge-on view of fiber block 620 of the edge that is inserted into device module 630. Fiber block 620 includes five access holes 711 of radius about 0.48 mm with centers separated by 1.40 mm formed in fiber block 620. V-grooves 626 for 0.125 mm fiber are formed, again with centers separated by about 1.40 mm and aligned with the centers of holes 711. As shown, the thickness of fiber block 620 is about 4.50 mm. The width of the opening of V-block 621 is about 7.0 mm. From FIG. 10B, the length of fiber block 620 is about 7.0 mm and the overall width is about 15.0 mm.

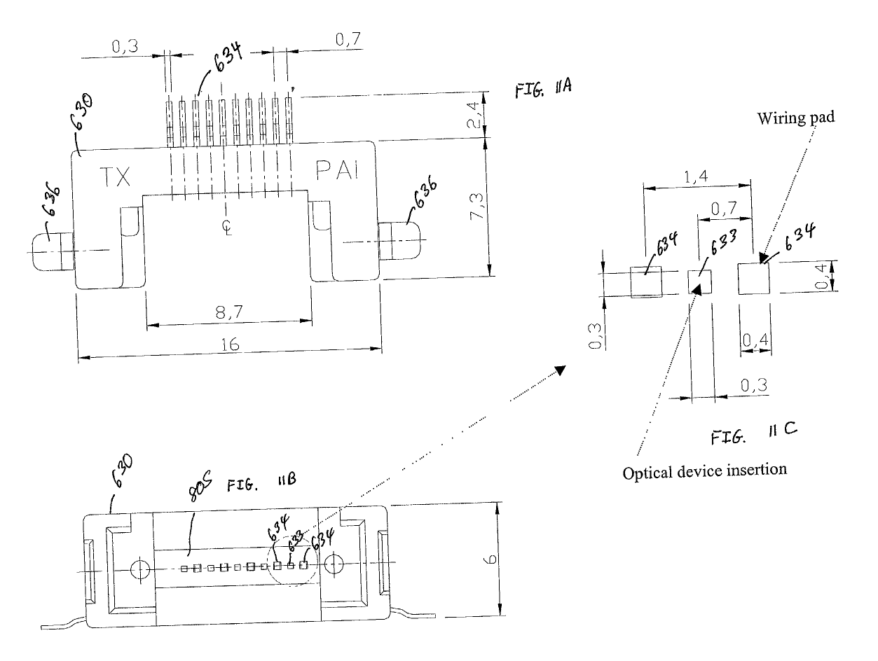

FIGS. 11A, 11B, and 11C illustrate a particular embodiment of device module 630. Device module 630 of FIGS. 11A, 11B, and 11C mates with fiber block 620 of FIGS. 10A and 10B. As shown in FIG. 11A, device module 630 includes electrical leads 634, each of which is about 0.3 mm in width with centers separated by about 0.7 mm. In some embodiments, the length of the exposed portion of electrical leads 634 is about 2.4 mm. The access for insertion of fiber block 620 is about 8.7 mm. The overall depth of device module 620 is about 7.3 mm. The overall width of device module 620 is about 16 mm. FIG. 11B shows a view from the side of device module 630 that receives fiber block 620. The thickness of device module 630 is about 6.0 mm. Device access 805 with device insertions 633 and exposed electrical leads 634 are shown. FIG. 11C shows the dimensions of insertions 633 and exposed spacings 634. Exposed electrical leads 634 are centered at spacings about 1.4 mm and interspersed with insertions 633. Insertion 633 is of size about 0.3 mm by about 0.3 mm while exposed electrical leads 634 are of size about 0.4 mm by about 0.4 mm.

The embodiments of connector 600 shown here are illustrative only and are not intended to be limiting. One skilled in the art will recognize various modifications to these amendments which are intended to be within the spirit and scope of this invention. For example, latch 612 of cover 610 and latch guide and holder 635 of optical device module 635 can be replaced by screw mechanisms or other form of connector for attaching cover 610 to device mounting module 630 such that fiber block 620 is held snuggly into device mounting block 630. As such, the invention is limited only by the following claims.

We claim:

1. An optical connector, comprising:
a fiber block, the fiber block including V-grooves and alignment mechanisms formed in the fiber block; and
a device module, the device module including electrical connectors, insertions, and opposite alignment mechanisms formed in the device module;
wherein, when the fiber block is inserted within the device module such that the alignment mechanisms of the fiber block and the opposite alignment mechanisms of the device module are in communications, the V-grooves and the insertions are aligned such that optical fiber cores mounted in the V-grooves are optically coupled with optical devices mounted in the insertions.

2. The connector of claim 1 wherein at least one of the alignment mechanisms is an alignment hole formed in the fiber block and a corresponding one of the opposite alignment mechanisms is a pin formed in the device module.

3. The connector of claim 1 wherein at least one of the alignment mechanisms is a pin formed in the fiber block and a corresponding one of the opposite alignment mechanisms is an alignment hole formed in the device module.

4. The connector of claim 1, wherein the fiber block further includes an access hole to receive optical fibers in relation to the V-grooves on which the cores of the optical fibers can be mounted.

5. The connector of claim 4, further including a cover that can be epoxied to the fiber block to hold the cores of the optical fibers into the V-grooves.

6. The connector of claim 1, wherein the insertions can be formed in a device area inset in the device module, where the device area can be filled with an optical epoxy to hold devices in place in the insertions.

7. The connector of claim 6, wherein the devices can be optical detectors.

8. The connector of claim 6, wherein the devices can be optical sources.

9. The connector of claim 1, wherein the device module includes latch guides and holders and further including a cover, the cover comprising a latch for insertion into the latch guide and holder and springs for holding the fiber block firmly into the device module when the cover is latched in place.

10. The connector of claim 9, wherein the device module includes wings for mechanical mounting on a printed circuit board.

11. A method of forming an optical connector, comprising:
forming a fiber block having V-grooves and at least one alignment mechanism;
forming a device mounting block having insertions and opposite alignment mechanism for each of the at least one alignment mechanism such that when the at least one alignment mechanism of the fiber block is coupled with the corresponding opposite alignment mechanism, the V-grooves are aligned with the insertions.

12. The method of claim 11, wherein at least one of the at least one alignment mechanism is an alignment hole and the corresponding opposite alignment mechanism is a pin.

13. The method of claim 11, wherein at least one of the at least one alignment mechanism is a pin and the corresponding opposite alignment mechanism is an alignment hole.

14. The method of claim 11, wherein forming a fiber block includes molding plastic to form the fiber block.

15. The method of claim 11, wherein forming a device module includes molding plastic to form the device module.

16. The method of claim 11, fuirther including forming a cover which can be attached to the device module and hold the fiber block in place with the device module.
